(19) United States
(12) Patent Application Publication
(10) Pub. No.: US 2004/0034876 A1
(43) Pub. Date: Feb. 19, 2004

(54) Variable data rate video entertainment system and method

(76) Inventor: Donald L. Schilling, Palm Beach Gardens, FL (US)

Correspondence Address: DAVID NEWMAN CHARTERED, Centennial Square, P.O. Box 2728, La Plata, MD, 20646-2728, US

(21) Appl. No.: 10/218,990

(22) Filed: Aug. 14, 2002

(51) Int. Cl. H04N 7/16; H04N 7/173

(52) U.S. Cl. 725/144; 725/138; 725/114; 725/91; 725/95; 725/98

(57) ABSTRACT

A headend controller selects a multiplicity of sub-communications channels for transmission through a communications channel to a remote-subscriber unit. The headend controller sends channel information indicating which channels from the plurality of sub-communications channels are the first multiplicity of sub-communications channels The remote-subscriber unit receives the first channel information and sets receiver means for receiving the first multiplicity of sub-communications channels from the headend. The headend demultiplexes the particular VOD or Internet content signal into data streams, and sends the data streams over the multiplicity of sub-communications channels, respectively, to the remote-subscriber unit. The remote-subscriber unit receives the data streams from the first multiplicity of sub-communications channels, and multiplexes the data streams for reassembling the particular VOD or Internet content signal.

### BACKGROUND OF THE INVENTION

This invention relates to cable and satellite distributed television and Internet signals, and more particularly to efficient use of capacity by adjusting and varying the number of channels on-demand and in real time.

### DESCRIPTION OF THE RELEVANT ART

Cable and satellites serve as a medium for sending television (TV) and Internet signals to users in a community. The TV signals typically are sent to a head-end and then distributed throughout the community. All TV programs, each sent as a separate signal, are sent to each house, apartment, etc. The user selects which program to view, by selecting the appropriate channel. If 200 channels are used, for example, each with a symbol rate of one megasymbols per second (Msymbols/sec), then a total symbol rate of 200 Msymbols/sec must be accommodated along the transmission path from the headend to each user, even when no user is using the system.

Consider, that in a community of 1000 users, at least one user might be watching one of the most popular 20 channels, and a few might be watching another 10 channels. Only 30 Msymbols/sec are required, and the remaining 170 Msymbols/sec could be used to provide high-speed access to video-on-demand, Internet or other content.

### SUMMARY OF THE INVENTION

A general object of the invention is the efficient use of spectrum in a cable and a satellite TV distribution system.

Another object of the invention is a TV distribution system which adjusts symbol rate, by varying the number of sub-communications channels, on demand and in real time.

An additional object of the invention is a TV distribution system which sends only those TV channels requested by remote-subscriber units.

According to the present invention, as embodied and broadly described herein, a television channel distribution system is provided, comprising a headend, a plurality of remote-subscriber units (RSUs), a communications channel, a plurality of control boxes, and a headend controller. The headend has a plurality of video signals available for distribution. N represents the total number of video signals available in the plurality of video signals. K represents the total number of remote-subscriber units in the plurality of remote-subscriber units. The communications channel may be from cable, fiber optics medium, or wireless path using radio waves. The communications channel has a plurality of sub-communications channels.

The plurality of control boxes are connected to the plurality of remote-subscriber units, respectively. The plurality of control boxes sends a plurality of control signals, respectively, to the headend. Each control box is connected to the headend through the communications channel, and to a respective remote-subscriber unit of the plurality of remote-subscriber unit. Each control box sends a control signal through the communications channel to the headend for requesting a particular VOD, or Internet, content signal of the plurality of video signals. The term “content signal” is used throughout to include VOD, Internet or other content type signals.

There may be 250 standard video programs for example, each having its own channel frequency, and a bandwidth of 6 MHz, 3 MHz if MPEG-2, or 1.5 MHz if MPEG-4 is employed. In other areas, video programs may have different bandwidth, for example, 8 MHz, 4 MHz if MPEG-2, or 2 MHz if MPEG-4 is employed. The term standard programming is used for these channels, since transmission of each of these programs occurs on the single channel, allocated to the program, once the program is selected by at least one user. The standard programs are what typically is found on a cable or satellite system as a channel for CNBC, MSNBC, A&E, HISTORY CHANNEL, ABC, CBS, etc.

When a special content signal, such as, video on demand (VOD) or an Internet download is requested by a remote-subscriber unit, the headend controller receives the control signal. The headend controller, in response to the control signal, selects a multiplicity of non-used video channels of the plurality of video channels, for distribution over the standard channels to the remote-subscriber unit requesting the VOD or Internet content signal. For example, if ten 6 MHz channels are used, then the download rate is 60 megasymbols per second. Each VOD or Internet content signal is in digital form. More particularly, the headend controller selects a first multiplicity of sub-communications channels from the plurality of communications channels, available for transmission through the communications channel to a particular remote-subscriber unit. The headend controller sends, on a control-information channel, to the particular remote-subscriber unit, first channel information, indicating which channels from the plurality of sub-communications channels are the first multiplicity of sub-communications channels to be used for transmitting a first portion of the particular VOD or Internet content signal from the headend to the particular remote-subscriber unit.

The particular remote-subscriber unit receives the first channel information from the headend controller. In response to the first channel information, the particular remote-subscriber unit sets receiver means for receiving the first multiplicity of sub-communications channels from the headend.

The headend forward-error-correction (FEC) encodes and then demultiplexes the particular VOD or Internet content signal into M1 data streams, packetizes and sends the M1 data streams over the first multiplicity of sub-communications channels, respectively, to the particular remote-subscriber unit. The remote-subscriber unit receives the M1 data streams from the first multiplicity of sub-communications channels, and multiplexes the M1 data streams for reassembling the first portion of the particular content signal. Packets will arrive at other users on the same communications channel, but the address on the packet will allow the appropriate user to receive the download. The header relates to a particular remote-subscriber unit.

Since the sub-communications channels are, in effect, borrowed from the standard TV program channels, the sub-communications channels must be returned to standard TV programming if any user requests a particular program. Thus, every T seconds, such as 0.5 seconds or 0.75 seconds, by way of example, the headend controller reassesses which standard programs are being viewed and therefore which channels are vacant. The headend controller then reassigns channels for the next T seconds. This process is repeated until the VOD, or Internet, content signal is downloaded to the remote-subscriber unit requesting the VOD or Internet content signal.

Additional objects and advantages of the invention are set forth in part in the description which follows, and in part are obvious from the description, or may be learned by practice of the invention. The objects and advantages of the invention also may be realized and attained by means of the instrumentalities and combinations particularly pointed out in the appended claims.

### BRIEF DESCRIPTION OF THE DRAWINGS

The accompanying drawings, which are incorporated in and constitute a part of the specification, illustrate preferred embodiments of the invention, and together with the description serve to explain the principles of the invention.

FIG. 1 is a block diagram of a headend connected through a communications channel to a number of control boxes and remote-subscriber units;

FIG. 2 is a block diagram illustrating a headend controller;

FIG. 3 illustrates a packet from a control box;

FIG. 4 is a block diagram of a control box interfacing a remote-subscriber unit;

FIG. 5 illustrates a packet for the Internet;

FIG. 6 is a diagram for interfacing the control box of a remote-subscriber unit to the Internet;

FIG. 7 is a functional block diagram at the headend;

FIG. 8 is a functional block diagram at a remote-subscriber unit;

FIG. 9 illustrates a packet with channel information sent from the headend controller to a particular remote-subscriber unit; and

FIG. 10 is a functional block diagram of the headend.

### DETAILED DESCRIPTION OF THE PREFERRED EMBODIMENTS

Reference now is made in detail to the present preferred embodiments of the invention, examples of which are illustrated in the accompanying drawings, wherein like reference numerals indicate like elements throughout the several views.

The present invention provides a system of delivering only those TV channels requested by at least one remote-subscriber unit, eliminating the necessity of broadcasting all TV channels to all remote-subscriber units at the same time.

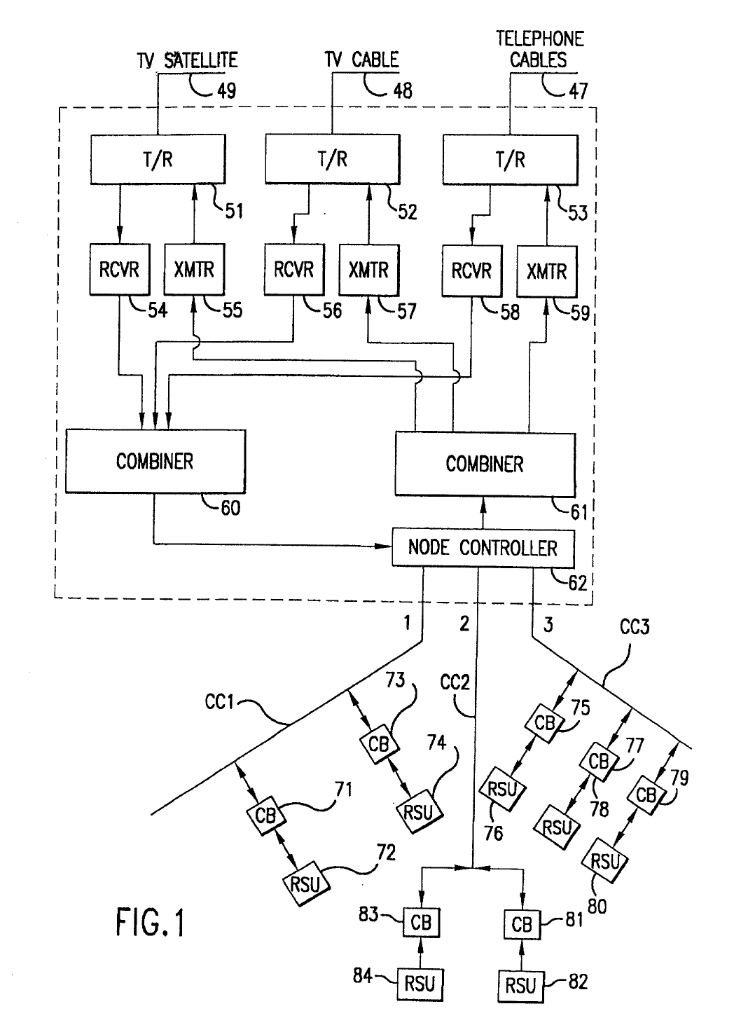

As illustratively shown in FIG. 1, a television channel distribution system is provided comprising a headend 50, a plurality of remote-subscriber units (RSUs) 72, 74, 76, 78, 80, 82, 84, a communications channel 39, and a plurality of control boxes 71, 73, 75, 77, 79, 81, 83. The headend 50 has a plurality of content signals available for distribution. The content signals may be video-on-demand content signals, Internet content signals or other content signals. The term “content signal”, as used herein, refers to any of the possible content signal, such as VOD content signal, Internet content signals, or other content signal. The content signals may arrive from different sources, such as satellite 49, TV cable 48, telephone cable 47, or may be stored within the system, such as on CD ROM, disk, or other storage media. N represents the total number of content signals available in the plurality of content signals. K represents the total number of remote-subscriber units in the plurality of remote scriber units 72, 74, 76, 78, 80, 82, 84. The communications channel 39, which connects the node controller 62 to each of the control boxes 71, 73, 75, 77, 79, 81, 83 may be from cable, fiber optics medium, or wireless path using radio waves.

The headend 50 includes, for each external source, typically a receiver, transmitter and transmit-receive (T/R) switch. The transmitter and receiver equivalently may be embodied as a transceiver. The transmitter transmits signals to the external source, and the receiver receives signals from the external source. The T/R switch, in each case, allows transmitting signals to be received from each external source.

In the exemplary arrangement of FIG. 1, by way of example, for satellite signals, a T/R switch 51 is coupled to the satellite ground antenna 49, and to a receiver 54 and transmitter 55. The receiver 54 receives signals from the satellite, and the transmitter 55 transmits signals to the satellite, using the T/R switch 51 and satellite ground antenna 49, as is well known in the art. For TV cable signals, a T/R switch 52 is coupled to a TV cable system 48 and to a receiver 56 and a transmitter 57. The receiver 56 receives signals from the TV cable 48, and the transmitter 57 transmits signals to the TV cable 48, using the T/R switch 52, as is well known in the art. For telephone cable signals, a T/R switch 53 is coupled to a telephone cable 47 and to a receiver 58 and a transmitter 59. The receiver 58 receives signals from the telephone cable 47, and the transmitter 59 transmits signals to the telephone cable 47, using the T/R switch 53, as is well known in the art.

Each receiver 54, 56, 58 is coupled to a receiver combiner 60, for combining signals from each receiver for transmission and distribution through the node controller 62, over a communications channel 39. Each transmitter 55, 57, 59 is coupled to a combiner 61 for combining signals from the communications channel 39 for transmission over the respective external source.

Node controller 62 is employed to separate the programs sent along the communications channels CC1, CC2, CC3, etc. Thus, a program requested by remote-subscriber unit 72, for example, will be sent along communications channel CC1 and not along communications channel CC2 or CC3. The node controller 62 also can be used to limit the number of remote-subscriber units, connected through a respective node, to be less than the number of channels available. Thus, if there are 250 channels, by way of example, then the node controller 62 may limit the number of remote-subscriber units connected to the respective node controller 62 to 240 remote-subscribers units. By having the node controller 62 limit the number of remote-subscriber units connected through a respective node to less than the total number of channels available at the node, ensures that some non-used channels are available.

Assume that 250 channels are available, by way of example, and if there are 240 users attached to each node, then there always are 10 unused channels. The frequency associated with the unused channels will change from time-to-tome as the users, remote-subscriber units, attached to each node change the channels viewed.

The plurality of remote-subscriber units (RSUs) 72, 74, 76, 78, 80, 82, 84, may be televisions, computers, or other devices for interaction with signals from the headend 50. The plurality of remote-subscriber units (RSUs) 72, 74, 76, 78, 80, 82, 84, is coupled to the communications channel 39 through the plurality of control boxes 71, 73, 75, 77, 79, 81, 83.

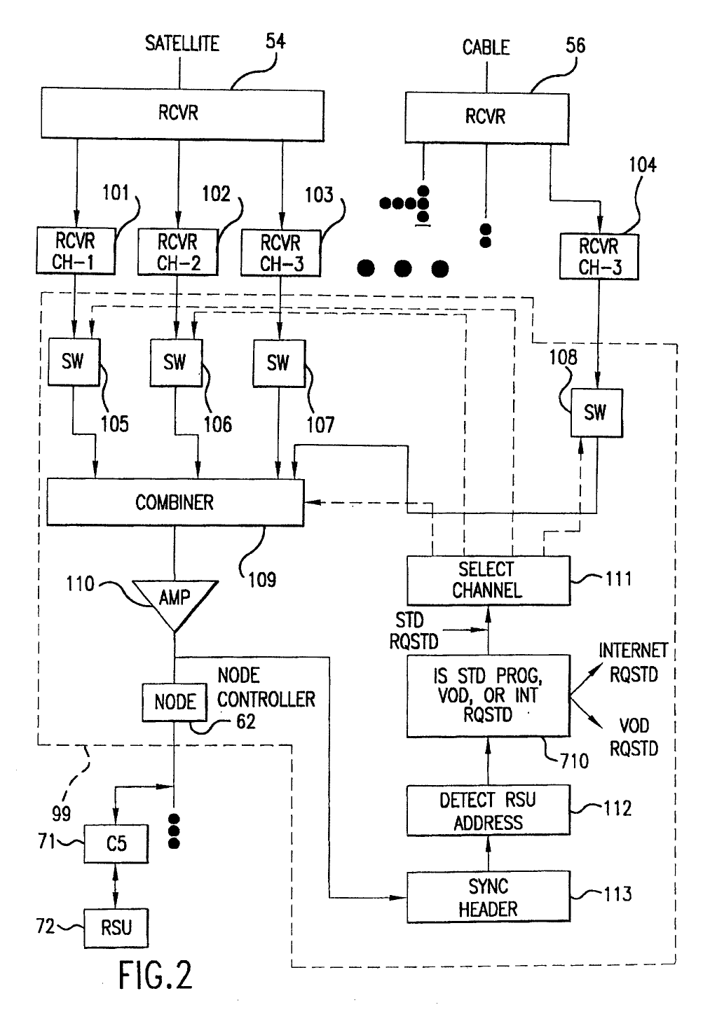

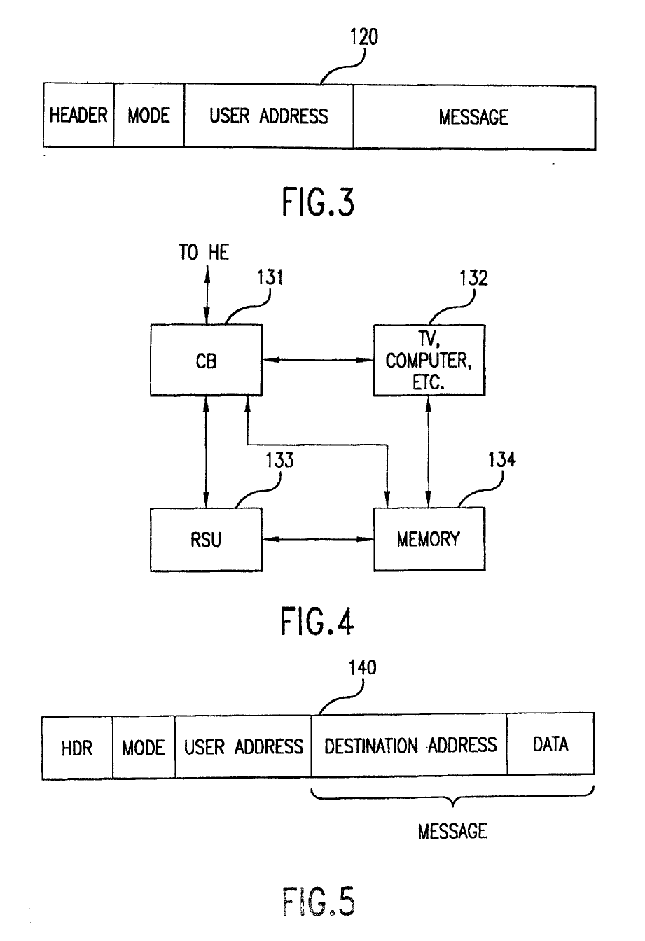

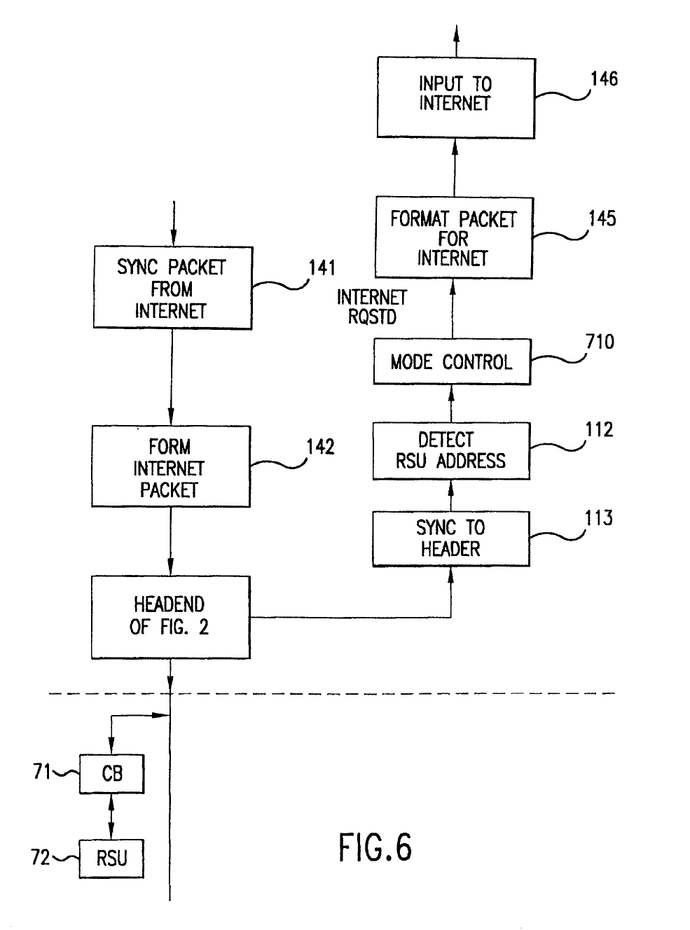

In FIG. 2, A headend controller 99 is added to FIG. 1. The headend controller 99 includes header synchronizer 113, user address detector 112, mode selector s710, channel selector 111, and a plurality of electronic switches 105, 106, 107, 108. The plurality of electronic switches 105, 106, 107, 108 may be embodied as a plurality of gates. Each receiver of FIG. 1, may have a plurality of receiver channels at an output. Thus, for receiver 54 and receiver 56, a plurality of content signals CH-1, Ch-2, CH-3, . . . , Ch-N, is available from a plurality of sub-receiver units 101, 102, 103, 104. The plurality of electronic switches 105, 106, 107, 108 control which of the plurality of content signals is available at receiver combiner 109.

The plurality of control boxes 71, 73, 75, 77, 79, 81, 83 is connected to the plurality of remote-subscriber units 72, 74, 76, 78, 80, 82, 84, respectively. The plurality of control boxes 71, 73, 75, 77, 79, 81, 83 sends a plurality of control signals, respectively, to the headend 50. Each control box is connected to the headend 50 and through the communications channels 39, and the node controller 62, and to a respective remote-subscriber unit of the plurality of remote-subscriber units 72, 74, 76, 78, 80, 82, 84. Each control box sends a control signal through the communications channel 39 to the headend 50 for requesting a particular TV signal of the plurality of TV signals CH-1, Ch-2, CH-3, Ch-N, or for requesting the special content signals: VOD programming, or Internet communications.

The headend controller 99, in response to the plurality of control signals from the plurality of control boxes 71, 73, 75, 77, 79, 81, 83, selects a plurality of content signals CH-1, CH-2, CH-3, . . . , CH-N, for distribution through the communications channel 39 to the plurality of remote-subscriber units 72, 74, 76, 78, 80, 82, 84. More particularly, the headend controller 99 is coupled to the communications channel 39. The headend controller 99 receives the plurality of control signals from the plurality of control boxes 71, 73, 75, 77, 79, 81, 83. In addition, the mode control 710 in the headend controller 99 may be requested to select one of a plurality of available VOD programs or Internet address which will be downloaded using the “borrowed” channels.

A representative control signal 120 is shown in FIG. 3. The control signal 120 typically includes a header, mode indicator, user address and message. For requesting a standard TV program, the mode indicates “STD TV” and the message indicates the “DESIRED CHANNEL”. The control signal 120 originates at a control box of the plurality of control boxes 71, 73, 75, 77, 79, 81, 83. The header of the control signal 120 is used for synchronization by header synchronizer 113. The user address detector 112 detects the user address in the control signal 120. The user address is a unique address assigned to each control box in the plurality of control boxes 71, 73, 75, 77, 79, 81, 83. By detecting the user address, the headend controller 99 knows from which remote-subscriber unit a particular control signal originated. This tells the node controller 62 over which node to send the requested programming. The mode control 710 indicates whether a standard TV channel or a VOD, or Internet, content signal is desired. If the standard TV channel is desired, then the channel selector 111 reads which TV channel is being selected by a particular remote-subscriber unit. In response to the information from the channel selector, a particular electronic switch from the plurality of electronic switches 105, 106, 107, 108 is activated to let the selected TV signal pass to the receiver combiner 60, for transmission and distribution to the respective remote-subscriber unit. The header synchronizer 113, user address detector 112, mode control 710 channel selector 111, and plurality of electronic switches 105, 106, 106, 108 may be embodied as discrete electronic circuits, embedded in or part of an application integrated circuit (ASIC), software controlling gate array logic, firmware or other electronic and/or software, as is well know in the art, for implementing such detectors and controllers. This is for standard programming, wherein a single program gets a single channel. For VOD programming, or Internet access, content programs, a single program uses all “borrowed” channels simultaneously.

FIG. 4 is a block diagram of a control box 131 interfacing a remote-subscriber unit 133 with a memory 134 for storing information at the remote-subscriber unit 133. The memory 134 can store a VOD or Internet content signal, downloaded from the headend 50. The control box 131 might interface a television, computer, etc. located at the remote-subscriber unit 133. The remote-subscriber unit 133 informs the control box 131 as to which content signal, such as VOD program or Internet access, the remote-subscriber unit 133 wants to receive. The control box 131 sends the control signal along the communications channel 39 to the headend 50, telling the headend to send the particular content signal, such as VOD program or Internet access. TV channels, for example, simultaneously are inputted to the control box from the headend. The control box is tuned to receive the requested TV frequency channel and it is detected and forwarded to the TV for viewing. For VOD programming or Internet access, the control box is tuned to receive the borrowed channels, each T seconds.

For computer operation, the remote-subscriber unit 133 might be a keyboard, or touch screen, which is connected to the hard drive 134 and monitor 132. For Internet operation the remote-subscriber unit 133 accesses the control box 131 and sends from the control box 131 packets along the communications channel 39 to the headend 50.

FIG. 5 illustrates a typical packet which might be used for accessing the Internet. The packet of FIG. 5 includes a header for synchronization, a “mode” indicator to select standard TV, VOD or Internet access, a user address which indicates the originator of the packet, and a “message” portion which, for Internet access, includes a destination address and data. FIGS. 3 and 5 are similar, each containing the header, mode, user address and message. When a VOD program is selected by the “mode” portion, then the message indicates which particular VOD program is requested.

FIG. 6 is a block diagram for interfacing a remote-subscriber unit 72 through a control box 71 along a communications channel 39 to the headend and then to the Internet from ports 47, 48 or 49 of FIG. 1. Signals or messages from the Internet arrive in packets. The header of the packet provides synchronization 141, then an Internet selector code is inserted. Messages or signals traveling to the Internet provide synchronization from the header 113, the Remote-subscriber Unit's address is determined 112, and that Internet access is requested 710. Then the message is detected for the Internet 710 from the Internet Selector portion of the packet. The packet is then formatted 145 for the Internet, and inputted 146 to the Internet.

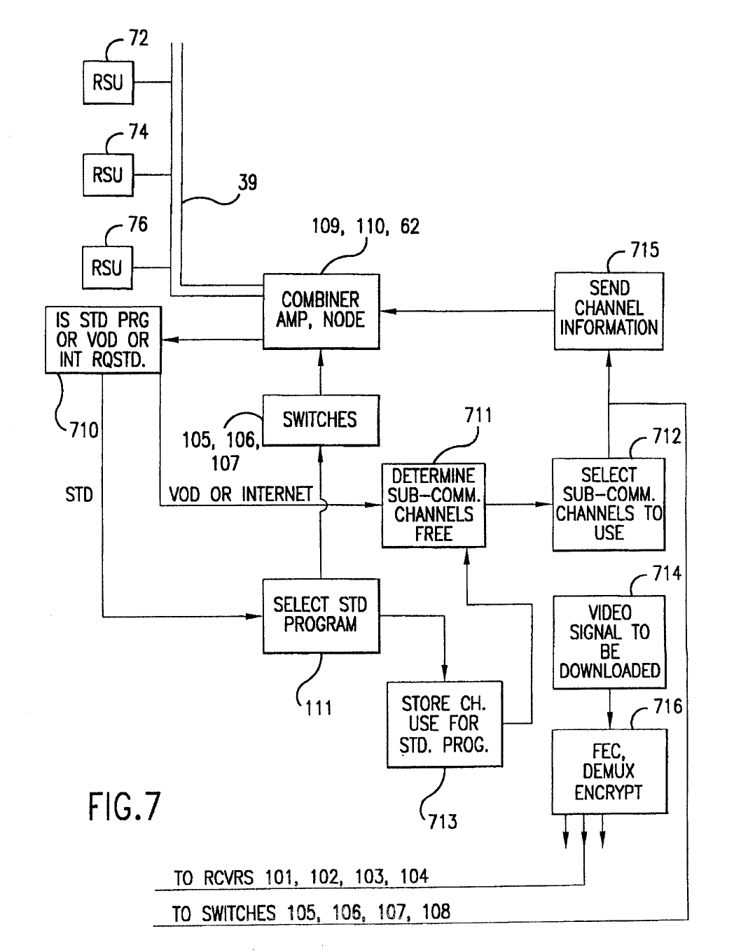

The headend (HE) controller is coupled to the communications channel 39. The headend controller 99 receives the plurality of control signals from the plurality of remote-subscriber units 72, 74, 76, 78, 80, 82, 84. In FIG. 7, in response to a particular control signal, the headend controller 99 determines 710 if regular programming or VOD programming or Internet access is requested. If VOD programming or Internet access is requested, then the headend controller determines 711 which sub-communications channels are being used, and therefore which channels can be borrowed from the total number of sub-communications channels. From the free or available sub-communications channels, the headend controller 99 selects 712, within a first time period, a first multiplicity of sub-communications channels from the plurality of sub-communications channels.

The first multiplicity of sub-communications channels are, at time of selection, currently available, within the first time period, for transmission through the communications channel 39 to a particular remote-subscriber unit. M1 represents a number of the first multiplicity of sub-communications channels within the communications channel. M1 is less than L. The headend controller 99 sends or transmits 715, to the particular remote-subscriber unit, first channel information indicating which channels from the plurality of communications channels are the first multiplicity of sub-communications channels to be “borrowed” and used for transmitting a first portion of a particular VOD or Internet content signal 714 from the headend to the remote-subscriber unit.

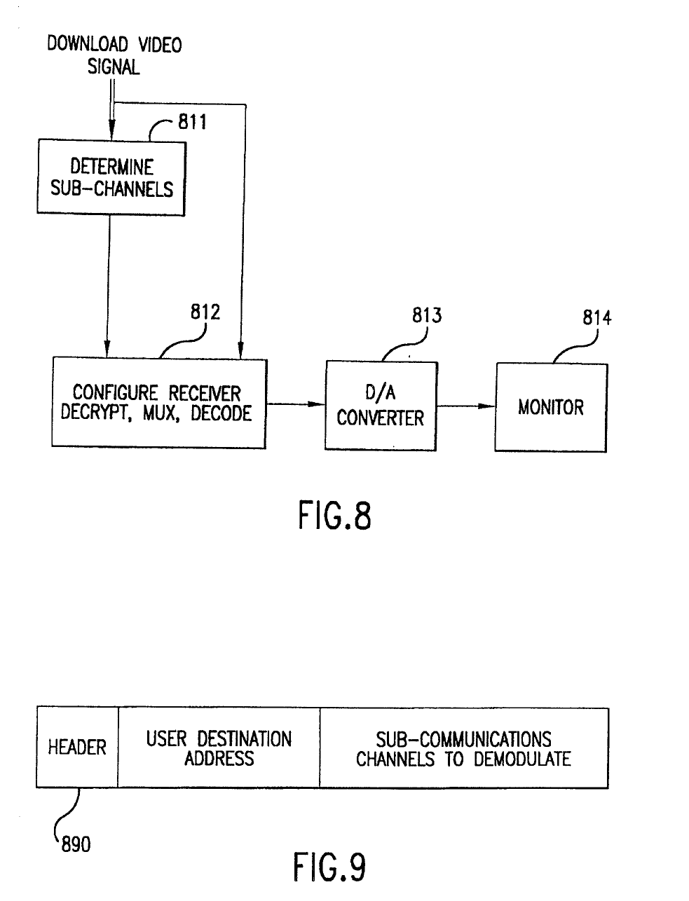

The particular remote-subscriber unit receives 811 of FIG. 8, the first channel information from the headend 99. In response to the first channel information, the particular remote-subscriber unit sets 812 receiver means, typically a plurality of receivers, for receiving the first multiplicity of sub-communications channels from the headend 99. The receiver means typically would include sufficient receiver for receiving the first multiplicity, and possibly the entire plurality, of sub-communications channels.

The headend 99 FEC encodes, demultiplexes, and optionally encrypts, and then packetizes 716 the particular VOD or Internet content signal 714 into M1 data streams, and sends the M1 data streams over the first multiplicity of sub-communications channels to the particular remote-subscriber unit. The remote-subscriber unit receives the M1 data streams from the first multiplicity of sub-communications channels, and depacketizes, if required, decrypts, multiplexes and FEC decodes the M1 data streams for reassembling the first portion of the particular VOD or Internet content signal 714.

The invention readily would extend to sending additional portions of the particular VOD or Internet content signal 714, using different sets or numbers from the plurality of sub-communications channels, for the multiplicity of sub-communications channels. Thus, the headend controller 99 further determines, in a second time period, availability of a second multiplicity of sub-communications channels. The headend controller can determine available of the second multiplicity of sub-communications channels by determining 710 which sub-communications channels are being used, and by determining 711 which sub-communications channels are free or available. The second multiplicity of sub-communications channels typically is not equal to the first multiplicity of sub-communications channels, either in number or in sub-channel selection. In response to the particular control signal, the headend controller 99 selects 712 the second multiplicity of sub-communications channels from the plurality of sub-communications channels, available, within the second time period, for transmission through the communications channel to a particular remote-subscriber unit. M2 represents a number of the second multiplicity of sub-communications channels within the communications channel. M2 is less than L. The headend controller 99 sends, to the particular remote-subscriber unit, second channel information indicating which channels from the plurality of communications channels are the second multiplicity of sub-communications channels to be used for transmitting a second portion of the VOD or Internet content signal from the headend to the remote-subscriber unit.

The particular remote-subscriber unit receiving the second channel information from the headend. In response to the second channel information, the particular remote-subscriber unit sets receiver means for receiving the second multiplicity of sub-communications channels from the headend.

The headend demultiplexes a second portion of the particular VOD or Internet content signal 714 into M2 data streams, and sends the M2 data streams over the second multiplicity of sub-communications channels to the particular remote-subscriber unit. The remote-subscriber unit receives the M2 data streams from the second multiplicity of sub-communications channels, and multiplexes the M2 data streams for reassembling the second portion of the particular VOD or Internet content signal 714.

For sending a third portion of the particular VOD or internet content signal 714, the headend controller 99 further determines, in a third time period, availability of a third multiplicity of sub-communications channels. The headend controller 99 can determine available of the third multiplicity of sub-communications channels by determining 710 which sub-communications channels are being used, and by determining 711 which sub-communications channels are free or available. The third multiplicity of sub-communications channels might not be equal to the second multiplicity of sub-communications channels. In response to the particular control signal, the headend controller 99 selects the third multiplicity of sub-communications channels from the plurality of sub-communications channels. The third multiplicity of sub-communications channels are available, within the third time period, for transmission through the communications channel to a particular remote-subscriber unit. M3 represents a number of the third multiplicity of sub-communications channels within the communications channel. M3 is less than L. The headend controller 99 sends, to the particular remote-subscriber unit, third channel information indicating which channels from the plurality of communications channels are the third multiplicity of sub-communications channels to be used for transmitting a third portion of the VOD or Internet content signal from the headend to the remote-subscriber unit.

The particular remote-subscriber unit receives the third channel information from the headend. In response to the third channel information, the particular remote-subscriber unit sets receiver means for receiving the third multiplicity of sub-communications channels from the headend.

The headend demultiplexes a third portion of the particular VOD or Internet content signal 714 into M3 data streams, and sends the M3 data streams over the third multiplicity of sub-communications channels to the particular remote-subscriber unit. The remote-subscriber unit receives the M3 data streams from the third multiplicity of sub-communications channels, and multiplexes the M3 data streams for reassembling the third portion of the particular Video or Internet content signal 714.

For sending a fourth portion of the particular content signal 714, the headend controller 99 further determines, in a fourth preset time period, availability of a fourth multiplicity of sub-communications channels. The headend controller 99 can determine available of the fourth multiplicity of sub-communications channels by determining 710 which sub-communications channels are being used, and by determining 711 which sub-communications channels are free or available. The fourth multiplicity of sub-communications channels is not equal to the third multiplicity of sub-communications channels. In response to the particular control signal, the headend controller 99 selects the fourth multiplicity of sub-communications channels from the plurality of sub-communications channels. The fourth multiplicity of sub-communications channels available, within the fourth time period, for transmission through the communications channel to a particular remote-subscriber unit. M4 represents a number of the fourth multiplicity of sub-communications channels within the communications channel. M4 is less than L. The headend controller 99 sends to the particular remote-subscriber unit, fourth channel information indicating which channels from the plurality of communications channels are the fourth multiplicity of sub-communications channels to be used for transmitting a fourth portion of the VOD or Internet content signal from the headend to the remote-subscriber unit.

The particular remote-subscriber unit receives the fourth channel information from the headend. In response to the fourth channel information, the particular remote-subscriber unit sets receiver means for receiving the fourth multiplicity of sub-communications channels from the headend.

The headend demultiplexes a fourth portion of the particular content signal 714 into M4 data streams, and sends the M4 data streams over the fourth multiplicity of sub-communications channels to the particular remote-subscriber unit. The remote-subscriber unit receives the M4 data streams from the fourth multiplicity of sub-communications channels, and multiplexes the M4 data streams for reassembling the fourth portion of the particular VOD or internet content signal 714.

For sending a fifth portion of the particular VOD or Internet content signal 714, the headend controller 99 further determines, in a fifth time period, availability of a fifth multiplicity of sub-communications channels. The headend controller 99 can determine available of the fifth multiplicity of sub-communications channels by determining 710 which sub-communications channels are being used, and by determining 711 which sub-communications channels are free or available. The fifth multiplicity of sub-communications channels might not be equal to the fourth multiplicity of sub-communications channels. In response to the particular control signal, the headend controller 99 selects the fifth multiplicity of sub-communications channels from the plurality of sub-communications channels, available, within the fifth time period, for transmission through the communications channel to a particular remote-subscriber unit. M5 represents a number of the fifth multiplicity of sub-communications channels within the communications channel. M5 is less than L. The headend controller 99 sends, to the particular remote-subscriber unit, fifth channel information indicating which channels from the plurality of communications channels are the fifth multiplicity of sub-communications channels to be used for transmitting a fifth portion of the VOD or Internet content signal from the headend to the remote-subscriber unit.

The particular remote-subscriber unit receives the fifth channel information from the headend. In response to the fifth channel information, the particular remote subscriber unit sets receiver means for receiving the fifth multiplicity of sub-communications channels from the headend.

The headend demultiplexes a fifth portion of the particular VOD or Internet content signal 714 into M5 data streams, and sends the M5 data streams over the fifth multiplicity of sub-communications channels to the particular remote-subscriber unit. The remote-subscriber unit receives the M5 data streams from the fifth multiplicity of sub-communications channels, and multiplexes the M5 data streams for reassembling the fifth portion of the particular VOD or Internet content signal 714.

The further extension to a sixth portion of the particular VOD or Internet content signal 714, and as would be understood to those skilled in the art, that the invention would extend to an Nth portion of the particular VOD or Internet content signal 714, the headend controller 99, by way of example, further determines, in a sixth time period, availability of a sixth multiplicity of sub-communications channels. The headend controller 99 can determine available channels of the sixth multiplicity of sub-communications channels by determining 710 which sub-communications channels are being used, and by determining 711 which sub-communications channels are free or available. The sixth multiplicity of sub-communications channels might not be equal to the fifth multiplicity of sub-communications channels. In response to the particular control signal, the headend controller 99 selects the sixth multiplicity of sub-communications channels from the plurality of sub-communications channels, available for transmission through the communications channel to a particular remote-subscriber unit. M6 represents a number of the sixth multiplicity of sub-communications channels within the communications channel. M6 is less than L. The headend controller 99 sends, to the particular remote-subscriber unit, sixth channel information indicating which channels from the plurality of communications channels are the sixth multiplicity of sub-communications channels to be used for transmitting a sixth portion of the VOD or Internet content signal from the headend to the remote-subscriber unit.

The particular remote-subscriber unit receives the sixth channel information from the headend. In response to the sixth channel information, the particular remote-subscriber unit sets receiver means for receiving the sixth multiplicity of sub-communications channels from the headend. The headend demultiplexes a sixth portion of the particular VOD or Internet content signal 714 into M6 data streams, and sends the M6 data streams over the sixth multiplicity of sub-communications channels to the particular remote-subscriber unit. The remote-subscriber unit receives the M6 data streams from the sixth multiplicity of sub-communications channels, and multiplexes the M6 data streams for reassembling the sixth portion of the particular VOD or Internet content signal 714.

Since the reassembled VOD or Internet content signal is digital, the digital VOD or Internet content signal, for viewing on an analog televison or monitor, would digital to analog convert 813 the digital VOD or Internet content signal to an analog signal, for viewing on a monitor 814.

The first, second, third, fourth, fifth and sixth channel information, and channel information in general, might be embodied as packets 890, as shown in FIG. 9.

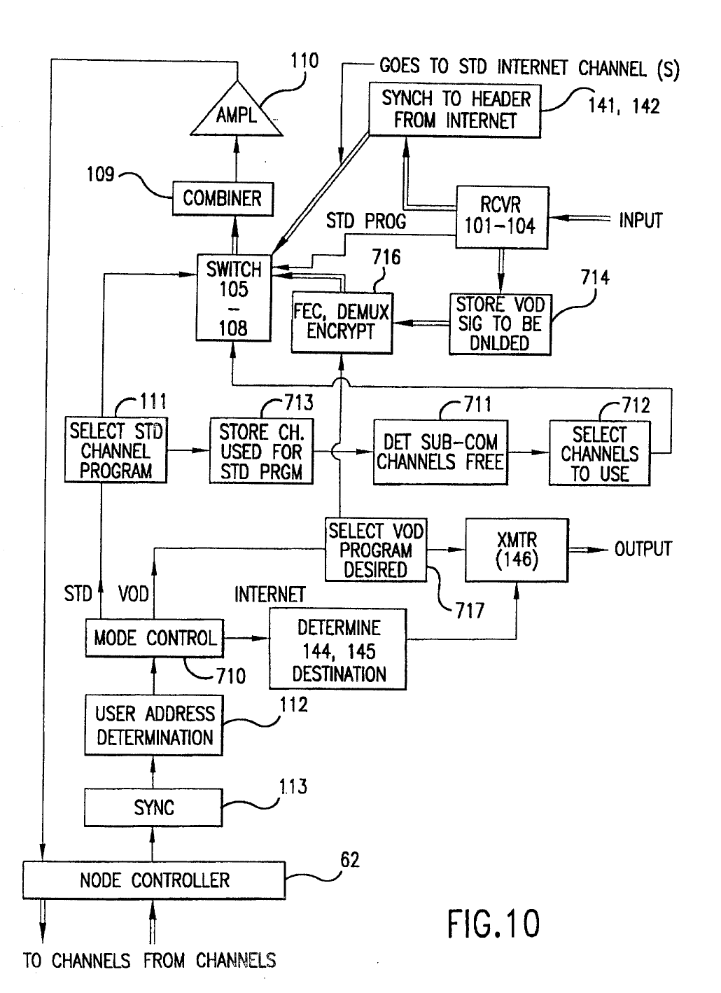

FIG. 10 is a composite drawing of the headend, which helps understand operation and use of the present invention.

Uplink

Signals from the channel 39 enter the node controller 62. The header is synchronized 113, then the remote-subscriber unit's address is read 112, and the mode controller 710 determines whether the user requested standard TV programming, or a special content signal, such a VOD or Internet.

If standard TV were requested, then the packet sent by the user determines what channel is requested 111, and the switches 105, 106, 107, 108 provide the correct receiver output 101-104 to send the requested TV channel to the appropriate remote-subscriber unit. The appropriate TV channel is then sent via the combiner 109, amplifier 110, through the correct channel. Since the particular channel requested now is in use, the particular channel cannot be “borrowed”. This information is stored in memory 713. The system then determines 711 which channels are free and selects 712 the appropriate channels to “borrow” if there is a special content signal to be rapidly downloaded.

If Internet access were requested, then the packet's destination is determined 144-145, and the packet is transmitted 146 to the Internet.

If a VOD program were desired, then the desired program request is selected 717 and sent to the transmitter 146, and forwarded to the content provider.

Downlink

The receiver input contains standard TV signals, and the VOD and Internet, special content signals.

The requested standard TV signals are selected by the switches 105-108, combined with the other signals 109, and sent along the appropriate communications channel through amplifier 110 and node controller 62, to the appropriate remote-subscriber unit.

If a VOD signal were requested, then the VOD signal is stored 714, and then FEC encoded, possibly encrypted, and then demultiplexed 716 into the appropriate number of “borrowed” channels. The resulting signal then is sent to the switches 105-108, combiner 109, amplifier 110 and then sent along the appropriate channel through amplifier 110 and node controller 62 to the appropriate remote-subscriber unit.

When an Internet download arrives at the receivers 101-104, the Internet download is synchronized and the user's address determined. The signal then goes to the switches 105-108, combined 109 with other signals 109, and sent along the appropriate channel through amplifier 110 and node controller 62 to the appropriate remote-subscriber unit.

It will be apparent to those skilled in the art that various modifications can be made to the variable data rate entertainment system and method of the instant invention without departing from the scope or spirit of the invention, and it is intended that the present invention cover modifications and variations of the variable data rate entertainment system and method provided they come within the scope of the appended claims and their equivalents.

I claim:

1. A television channel distribution system comprising:
a headend having a plurality of content signals available for distribution, where N represents a number of content signals in the plurality of content signals;
a plurality of remote-subscriber units (RSUs), where K represents a number of remote-subscriber units in the plurality of remote-scriber units;
a communications channel including at least one of cable, fiber optics medium, or wireless path using radio waves, said communications channel having a plurality of sub-communications channels, where L represents a number of sub-communications channels within the communications channel; and
a plurality of control boxes for sending a plurality of control signals, respectively, with each control box connected to the headend and through the communications channel to a respective remote-subscriber unit of the plurality of remote-subscriber units, each control box for sending a control signal through the communications channel to the headend for requesting a particular content signal of the plurality of content signals;
a headend controller, coupled to the communications channel, for receiving the plurality of control signals, said headend controller, responsive to a particular control signal, for selecting a first multiplicity of sub-communications channels from the plurality of sub-communications channels, where M1 represents a number of the first multiplicity of sub-communications channels within the communications channel, available for transmission through the communications channel to a particular remote-subscriber unit, with M1 less than L, said headend controller for sending, to the particular remote-subscriber unit, first channel information indicating which channels from the plurality of communications channels are the first multiplicity of sub-communications channels to be used for transmitting a first portion of a particular content signal from the headend to the remote-subscriber unit;
said particular remote-subscriber unit for receiving the first channel information from the headend, responsive to the first channel information, for setting receiver means for receiving the first multiplicity of sub-communications channels from the headend;
said headend for demultiplexing the particular content signal into M1 data streams, and for sending the M1 data streams over the first multiplicity of sub-communications channels to the particular remote-subscriber unit; and
said particular remote-subscriber unit for receiving the M1 data streams from the first multiplicity of sub-communications channels, and for multiplexing the M1 data streams for reassembling the first portion of the particular content signal.

2. The televison channel distribution system as set forth in claim 1, with:
said Headend controller further determining, in a preset time period, availability of a second multiplicity of sub-communications channels, with the second multiplicity of sub-communications channels not equal to the first multiplicity of sub-communications channels, said Headend controller, responsive to the particular control signal, for selecting the second multiplicity of sub-communications channels from the plurality of sub-communications channels, where M2 represents a number of the second multiplicity of sub-communications channels within the communications channel, available for transmission through the communications channel to a particular remote-subscriber unit, with M2 less than L, said Headend controller for sending, to the particular remote-subscriber unit, second channel information indicating which channels from the plurality of communications channels are the second multiplicity of sub-communications channels to be used for transmitting a second portion of the content signal from the headend to the remote-subscriber unit;
said particular remote-subscriber unit for receiving the second channel information from the headend, responsive to the second channel information, for setting receiver means for receiving the second multiplicity of sub-communications channels from the headend;
said headend for demultiplexing a second portion of the particular content signal into M2 data streams, and for sending the M2 data streams over the second multiplicity of sub-communications channels to the particular remote-subscriber unit; and
said particular remote-subscriber unit for receiving the M2 data streams from the second multiplicity of sub-communications channels, and for multiplexing the M2 data streams for reassembling the second portion of the particular content signal.

3. The televison channel distribution system as set forth in claim 2, with:
said Headend controller further determining, in the preset time period, availability of a third multiplicity of sub-communications channels, with the third multiplicity of sub-communications channels not equal to the second multiplicity of sub-communications channels, said Headend controller, responsive to the particular control signal, for selecting the third multiplicity of sub-communications channels from the plurality of sub-communications channels, where M3 represents a number of the third multiplicity of sub-communications channels within the communications channel, available for transmission through the communications channel to a particular remote-subscriber unit, with M3 less than L, said Headend controller for sending, to the particular remote-subscriber unit, third channel information indicating which channels from the plurality of communications channels are the third multiplicity of sub-communications channels to be used for transmitting a third portion of the content signal from the headend to the remote-subscriber unit;
said particular remote-subscriber unit for receiving the third channel information from the headend, responsive to the third channel information, for setting receiver means for receiving the third multiplicity of sub-communications channels from the headend;
said headend for demultiplexing a third portion of the particular content signal into M3 data streams, and for sending the M3 data streams over the third multiplicity of sub-communications channels to the particular remote-subscriber unit; and
said particular remote-subscriber unit for receiving the M3 data streams from the third multiplicity of sub-communications channels, and for multiplexing the M3 data streams for reassembling the third portion of the particular content signal.

4. The televison channel distribution system as set forth in claim 3, with:
said Headend controller further determining, in the preset time period, availability of a fourth multiplicity of sub-communications channels, with the fourth multiplicity of sub-communications channels not equal to the third multiplicity of sub-communications channels, said Headend controller, responsive to the particular control signal, for selecting the fourth multiplicity of sub-communications channels from the plurality of sub-communications channels, where M4 represents a number of the fourth multiplicity of sub-communications channels within the communications channel, available for transmission through the communications channel to a particular remote-subscriber unit, with M4 less than L, said Headend controller for sending, to the particular remote-subscriber unit, fourth channel information indicating which channels from the plurality of communications channels are the fourth multiplicity of sub-communications channels to be used for transmitting a fourth portion of the content signal from the headend to the remote-subscriber unit;
said particular remote-subscriber unit for receiving the fourth channel information from the headend, responsive to the fourth channel information, for setting receiver means for receiving the fourth multiplicity of sub-communications channels from the headend;
said headend for demultiplexing a fourth portion of the particular content signal into M4 data streams, and for sending the M4 data streams over the fourth multiplicity of sub-communications channels to the particular remote-subscriber unit; and
said particular remote-subscriber unit for receiving the M4 data streams from the fourth multiplicity of sub-communications channels, and for multiplexing the M4 data streams for reassembling the fourth portion of the particular content signal.

5. The televison channel distribution system as set forth in claim 4, with:
said Headend controller further determining, in the preset time period, availability of a fifth multiplicity of sub-communications channels, with the fifth multiplicity of sub-communications channels not equal to the fourth multiplicity of sub-communications channels, said Headend controller, responsive to the particular control signal, for selecting the fifth multiplicity of sub-communications channels from the plurality of sub-communications channels, where M5 represents a number of the fifth multiplicity of sub-communications channels within the communications channel, available for transmission through the communications channel to a particular remote-subscriber unit, with M5 less than L, said Headend controller for sending, to the particular remote-subscriber unit, fifth channel information indicating which channels from the plurality of communications channels are the fifth multiplicity of sub-communications channels to be used for transmitting a fifth portion of the content signal from the headend to the remote-subscriber unit;
said particular remote-subscriber unit for receiving the fifth channel information from the headend, responsive to the fifth channel information, for setting receiver means for receiving the fifth multiplicity of sub-communications channels from the headend;
said headend for demultiplexing a fifth portion of the particular content signal into M5 data streams, and for sending the M5 data streams over the fifth multiplicity of sub-communications channels to the particular remote-subscriber unit; and
said particular remote-subscriber unit for receiving the M5 data streams from the fifth multiplicity of sub-communications channels, and for multiplexing the M5 data streams for reassembling the fifth portion of the particular content signal.

6. The televison channel distribution system as set forth in claim 5, with:
said Headend controller further determining, in the preset time period, availability of a sixth multiplicity of sub-communications channels, with the sixth multiplicity of sub-communications channels not equal to the fourth multiplicity of sub-communications channels, said Headend controller, responsive to the particular control signal, for selecting the sixth multiplicity of sub-communications channels from the plurality of sub-communications channels, where M6 represents a number of the sixth multiplicity of sub-communications channels within the communications channel, available for transmission through the communications channel to a particular remote-subscriber unit, with M6 less than L, said Headend controller for sending, to the particular remote-subscriber unit, sixth channel information indicating which channels from the plurality of communications channels are the sixth multiplicity of sub-communications channels to be used for transmitting a sixth portion of the content signal from the headend to the remote-subscriber unit;
said particular remote-subscriber unit for receiving the sixth channel information from the headend, responsive to the sixth channel information, for setting receiver means for receiving the sixth multiplicity of sub-communications channels from the headend;
said headend for demultiplexing a sixth portion of the particular content signal into M6 data streams, and for sending the M6 data streams over the sixth multiplicity of sub-communications channels to the particular remote-subscriber unit; and
said particular remote-subscriber unit for receiving the M6 data streams from the sixth multiplicity of sub-communications channels, and for multiplexing the M6 data streams for reassembling the sixth portion of the particular content signal.

7. A television channel distribution method, for use between a headend having a plurality of content signals available for distribution, where N represents a number of content signals in the plurality of content signals and a plurality of remote-subscriber units (RSUs), where K represents a number of remote-subscriber units in the plurality of remote-scriber units, using a communications channel including at least one of cable, fiber optics medium, or wireless path using radio waves, said communications channel having a plurality of sub-communications channels, where L represents a number of sub-communications channels within the communications channel, comprising the steps of:
sending, from a plurality of control boxes connected to the plurality of remote-subscriber units, a control signal through the communications channel to the headend for requesting a particular content signal of the plurality of content signals;
receiving, at the headend, the plurality of control signals;
selecting, at the headend, in response to a particular control signal, a first multiplicity of sub-communications channels from the plurality of sub-communications channels, where M1 represents a number of the first multiplicity of sub-communications channels within the communications channel, available for transmission through the communications channel to a particular remote-subscriber unit, with M1 less than L;
sending, from the headend to the particular remote-subscriber unit, first channel information indicating which channels from the plurality of communications channels are the first multiplicity of sub-communications channels to be used for transmitting a first portion of a particular content signal from the headend to the remote-subscriber unit;
receiving, at the particular remote-subscriber unit, the first channel information from the headend
setting, at the particular remote-subscriber unit, in response to the first channel information, receiver means for receiving the first multiplicity of sub-communications channels from the headend;
demultiplexing, at the headend, the particular content signal into M1 data streams;
sending, from the headend, the M1 data streams over the first multiplicity of sub-communications channels to the particular remote-subscriber unit;
receiving, at the particular remote-subscriber unit, the M1 data streams from the first multiplicity of sub-communications channels; and
multiplexing the M1 data streams for reassembling the first portion of the particular content signal.

8. The televison channel distribution method as set forth in claim 7, further comprising the steps of:
determining, at the headend, in a preset time period, availability of a second multiplicity of sub-communications channels, with the second multiplicity of sub-communications channels not equal to the first multiplicity of sub-communications channels;
selecting, in response to the particular control signal, the second multiplicity of sub-communications channels from the plurality of sub-communications channels, where M2 represents a number of the second multiplicity of sub-communications channels within the communications channel, available for transmission through the communications channel to a particular remote-subscriber unit, with M2 less than L;
sending, to the particular remote-subscriber unit, second channel information indicating which channels from the plurality of communications channels are the second multiplicity of sub-communications channels to be used for transmitting a second portion of the content signal from the headend to the remote-subscriber unit;
receiving, at the particular remote-subscriber unit, the second channel information from the headend;
setting, in response to the second channel information, receiver means for receiving the second multiplicity of sub-communications channels from the headend;
demultiplexing, at the headend, a second portion of the particular content signal into M2 data streams;
sending the M2 data streams over the second multiplicity of sub-communications channels to the particular remote-subscriber unit;
receiving at the particular remote-subscriber unit, the M2 data streams from the second multiplicity of sub-communications channels; and
multiplexing the M2 data streams for reassembling the second portion of the particular content signal.

9. The televison channel distribution method as set forth in claim 8, further including the steps of:
determining, at the headend, in the preset time period, availability of a third multiplicity of sub-communications channels, with the third multiplicity of sub-communications channels not equal to the second multiplicity of sub-communications channels;
selecting, in response to the particular control signal, the third multiplicity of sub-communications channels from the plurality of sub-communications channels, where M3 represents a number of the third multiplicity of sub-communications channels within the communications channel, available for transmission through the communications channel to a particular remote-subscriber unit, with M3 less than L;
sending, to the particular remote-subscriber unit, third channel information indicating which channels from the plurality of communications channels are the third multiplicity of sub-communications channels to be used for transmitting a third portion of the content signal from the headend to the remote-subscriber unit;
receiving, at the particular remote-subscriber unit, the third channel information from the headend;
setting, in response to the third channel information, receiver means for receiving the third multiplicity of sub-communications channels from the headend;
demultiplexing, at the headend, a third portion of the particular content signal into M3 data streams;
sending the M3 data streams over the third multiplicity of sub-communications channels to the particular remote-subscriber unit;
receiving, at the particular remote-subscriber unit, the M3 data streams from the third multiplicity of sub-communications channels; and
multiplexing the M3 data streams for reassembling the third portion of the particular content signal.

10. The televison channel distribution method as set forth in claim 9, further including the steps of:
determining, at the headend, in the preset time period, availability of a fourth multiplicity of sub-communications channels, with the fourth multiplicity of sub-communications channels not equal to the third multiplicity of sub-communications channels;
selecting, in response to the particular control signal, the fourth multiplicity of sub-communications channels from the plurality of sub-communications channels, where M4 represents a number of the fourth multiplicity of sub-communications channels within the communications channel, available for transmission through the communications channel to a particular remote-subscriber unit, with M4 less than L;
sending, to the particular remote-subscriber unit, fourth channel information indicating which channels from the plurality of communications channels are the fourth multiplicity of sub-communications channels to be used for transmitting a fourth portion of the content signal from the headend to the remote-subscriber unit;
receiving, at the particular remote-subscriber unit, the fourth channel information from the headend;
setting, in response to the fourth channel information, receiver means for receiving the fourth multiplicity of sub-communications channels from the headend;
demultiplexing, at the headend, a fourth portion of the particular content signal into M4 data streams;
sending the M4 data streams over the fourth multiplicity of sub-communications channels to the particular remote-subscriber unit;
receiving, at the particular remote-subscriber unit, the M4 data streams from the fourth multiplicity of sub-communications channels; and
multiplexing the M4 data streams for reassembling the fourth portion of the particular content signal.

11. The televison channel distribution method as set forth in claim 10, further including the steps of:
determining, at the headend, in the preset time period, availability of a fifth multiplicity of sub-communications channels, with the fifth multiplicity of sub-communications channels not equal to the fourth multiplicity of sub-communications channels;
selecting, in response to the particular control signal, the fifth multiplicity of sub-communications channels from the plurality of sub-communications channels, where M5 represents a number of the fifth multiplicity of sub-communications channels within the communications channel, available for transmission through the communications channel to a particular remote-subscriber unit, with M5 less than L;
sending, to the particular remote-subscriber unit, fifth channel information indicating which channels from the plurality of communications channels are the fifth multiplicity of sub-communications channels to be used for transmitting a fifth portion of the content signal from the headend to the remote-subscriber unit;
receiving, at the particular remote-subscriber unit, the fifth channel information from the headend;
setting, in response to the fifth channel information, receiver means for receiving the fifth multiplicity of sub-communications channels from the headend;
demultiplexing, at the headend, a fifth portion of the particular content signal into M5 data streams;
sending the M5 data streams over the fifth multiplicity of sub-communications channels to the particular remote-subscriber unit;
receiving, at the particular remote-subscriber unit, the M5 data streams from the fifth multiplicity of sub-communications channels; and
multiplexing the M5 data streams for reassembling the fifth portion of the particular content signal.

12. The televison channel distribution method as set forth in claim 11, further including the steps of:
determining, at the headend, in the preset time period, availability of a sixth multiplicity of sub-communications channels, with the sixth multiplicity of sub-communications channels not equal to the fourth multiplicity of sub-communications channels;
selecting, in response to the particular control signal, the sixth multiplicity of sub-communications channels from the plurality of sub-communications channels, where M6 represents a number of the sixth multiplicity of sub-communications channels within the communications channel, available for transmission through the communications channel to a particular remote-subscriber unit, with M6 less than L;
sending, to the particular remote-subscriber unit, sixth channel information indicating which channels from the plurality of communications channels are the sixth multiplicity of sub-communications channels to be used for transmitting a sixth portion of the content signal from the headend to the remote-subscriber unit;
receiving, at the particular remote-subscriber unit, the sixth channel information from the headend;
setting, in response to the sixth channel information, receiver means for receiving the sixth multiplicity of sub-communications channels from the headend;
demultiplexing, at the headend, a sixth portion of the particular content signal into M6 data streams;
sending the M6 data streams over the sixth multiplicity of sub-communications channels to the particular remote-subscriber unit;
receiving, at the particular remote-subscriber unit, the M6 data streams from the sixth multiplicity of sub-communications channels; and
multiplexing the M6 data streams for reassembling the sixth portion of the particular content signal.
